(19) United States
(12) Patent Application Publication
(10) Pub. No.: US 2013/0099896 A1
(43) Pub. Date: Apr. 25, 2013

(54) Sensor Location and Tagging System

(71) Applicants: Jari Arkko, Kauniainen (FI); Oscar Novo Diaz, Helsinki (FI); Heidi-Maria Rissanen, Helsinki (FI)

(72) Inventors: Jari Arkko, Kauniainen (FI); Oscar Novo Diaz, Helsinki (FI); Heidi-Maria Rissanen, Helsinki (FI)

(73) Assignee: TELEFONAKTIEBOLAGET L M ERICSSON (PUBL), Stockholm (SE)

(21) Appl. No.: 13/415,458

(22) Filed: Mar. 8, 2012

Related U.S. Application Data
(60) Provisional application No. 61/550,667, filed on Oct. 24, 2011.

(51) Int. Cl. G06K 7/01

(52) U.S. Cl. 340/10.1

(57) ABSTRACT

Methods and systems for determining a location of a device and tagging signals from the device with the location involve receiving, by a plurality of positioning devices, a signal sent by the device; determining, by each of the plurality of positioning devices, respective location information based on the signal; determining, based on the respective location information of each of the plurality of positioning devices, the location of the device; and forming, from the signal, a second signal annotated with the location of the device.

This application claims the benefit of the filing date of U.S. Provisional Patent Application No. 61/550,667 filed on Oct. 24, 2011, which is incorporated here by reference.

### TECHNICAL FIELD

This invention relates to communication networks and more particularly to methods and apparatus for locating devices in such networks and tagging devices with their identities.

### BACKGROUND

Location systems configured for indoor and other uses can be used in many ways, e.g., asset management. Current location systems have been made primarily to track persons or devices, such as smart phones, that transmit relatively powerful signals. Real-world applications of such systems include determination of the location of a shop inside a shopping mall or of a service inside an airport or of emergency services personnel inside a building or of equipment inside a plant.

Progress in location systems has been made primarily in the positioning algorithms and in the signaling systems, which can be based on the Global Positioning System (GPS), radio frequency identification (RFID) tags and devices, or cellular telephony.

Systems for determining the locations of devices, such as sensors or actuators, in a network typically use wireless devices for monitoring signals from the devices that can then be relayed to one or more other network nodes, such as a gateway or base unit. The gateway or base unit processes the relayed signals and determines and stores the sensor location(s) based on measured strength or time-of-arrival (ToA) of the signals at the gateway.

U.S. Patent Application Publication U.S. 2006/0258292 relates to a sensor network in which sensors lacking positioning functionality can be located by using a terminal having positioning functionality, such as a cellular telephone having a GPS receiver. Information received from the sensor by the terminal can be reported to a wireless base station for further processing and storage.

U.S. Pat. No. 7,289,466 relates to determining the location of a wireless device, such as a sensor. The system uses anchor devices having known positions to capture normal output signals of the sensor and determine the ToAs of the signals. The location calculation can be performed by any system node having computational capability, or the ToA information can be transmitted to a gateway for location calculation. The anchor devices can also act as beacons, which is to say, they can wirelessly broadcast information to the sensor.

U.S. Patent Application Publication U.S. 2005/0136972 relates to plug-in network appliances for a wireless communication system. Based on the locations of the power outlets, the positions of the network appliances can be determined. The network appliances can communicate with wireless devices, such as sensors, and with central equipment, such as a server, using more than one communication protocol and wired and wireless links. The network appliances can be used as a network monitor and deliver location information to the server, with network appliances measuring signal strengths from other devices.

European Publication EP 2280563 describes a wireless network of stationary and mobile wireless devices, such as sensors. Relay nodes in the network can convey sensor location information, such as signal strength, to a gateway.

A sensor network, such as an indoor temperature measurement network, would benefit from being able to configure itself and determine the locations of its various sensors automatically, without needing manual registration of the location of each sensor. Actuator networks, such as a network of switches for actuating electrical devices, such as lamps, heating and cooling systems, etc., and other networks would benefit similarly.

It is also desirable for a network to coordinate location information from sensors, actuators, and other devices in a constrained network, which is a network in which the devices have limited information processing capabilities and which cannot typically support any special equipment.

### SUMMARY

This invention relates to location systems that do not substantially modify system devices. The location of a system device is obtained with minimal interaction with the device. Positioning devices are provided that interact with the system device(s) and with a central node to obtain the location(s) of the system device(s).

According to aspects of the invention, there is provided a method of determining a location of a device and tagging signals from the device with the location. The method includes receiving, by a plurality of positioning devices, a signal sent by the device; determining, by each of the plurality of positioning devices, respective location information based on the signal; determining, based on the respective location information of each of the plurality of positioning devices, the location of the device; and forming, from the signal, a second signal annotated with the location of the device.

According to further aspects of the invention, there is provided a system for determining a location of a device and tagging signals from the device with the location. The system includes a plurality of positioning devices configured for receiving a signal sent by the device and for determining respective location information based on the signal; and a system node configured for determining, based on the respective location information of each of the plurality of positioning devices, the location of the device and for forming from the signal a second signal annotated with the location of the device. According to further aspects of the invention, there is provided a system node for a system for determining a location of a device and tagging signals from the device with the location. The system node includes an electronic processor circuit configured for determining, based on respective location information included in a plurality of different positioning signals received by the system node, the location of the device; and for forming, from a signal sent by the device and received by the system node, a second signal annotated with the location of the device. The respective location information is based on the signal sent by the device.

### BRIEF DESCRIPTION OF THE DRAWINGS

The several features, objects, and advantages of this invention will become apparent by reading this description in conjunction with the drawings, in which like elements are identified by like reference characters and in which:

FIG. 1 illustrates an example of a location system in accordance with aspects of this invention; and

FIG. 2 is a diagram of an example of signal flow in the location system of FIG. 1;

FIG. 3 is a flow chart of an example of a method of determining the location of a device and tagging signals from the device with the location; and

FIG. 4 is a block diagram of an example of a device or node in a location system.

### DETAILED DESCRIPTION

A location system in accordance with this invention can include a set of one or more positioning devices and a central node, which can itself be a positioning device. The number of positioning devices in the set can depend on the size of the area covered by the location system, the respective signal strengths of the positioning devices, and the signaling protocols used by the positioning devices. For example, if triangulation is used for determining location, the set includes at least three positioning devices, assuming the central node is not a positioning device.

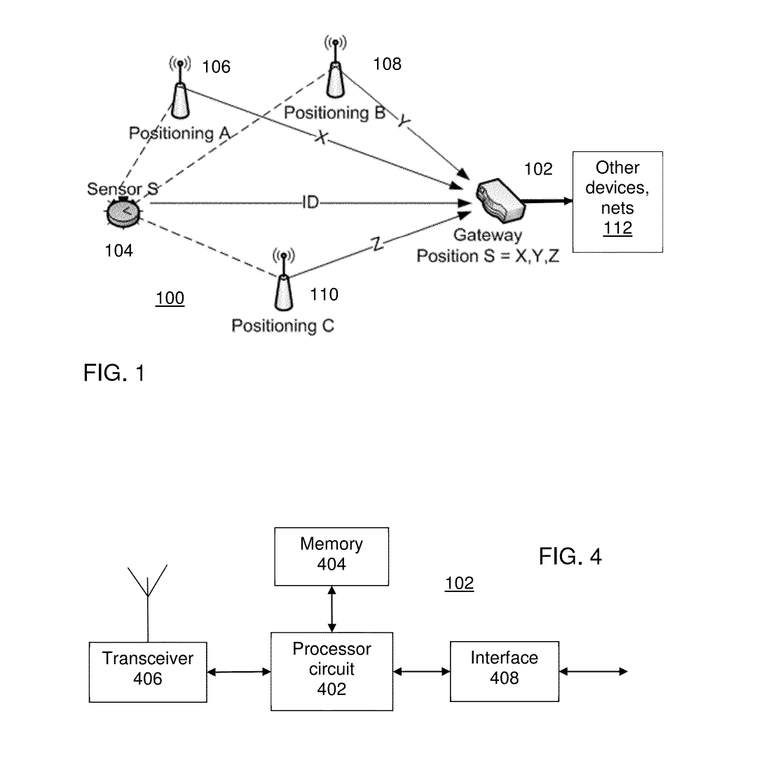

FIG. 1 is a diagram of an example of a location system 100 that includes a central node 102, a device 104 that is to be located, and three positioning devices 106, 108, 110, or communication nodes, used for the location. The device or node 104 can be a sensor, an actuator, or another device, and the central node 102 can be a gateway or proxy processor or computer that communicates with other devices or networks (not shown) as indicated by the arrow. Hence, a mechanism for locating the device 104 in the system 100 comprises the central node 102 and the set of three positioning devices 106, 108, 110.

The positioning devices or nodes 106, 108, 110 typically have locations that are known to the central node 102 or a node in communication with it, and they are able to communicate with the device 104 and with the central node 102. As depicted in FIG. 1, the positioning devices communicate wirelessly with the node 102 and device 104, but that is not necessary as wired or wireless communication or any combination in any convenient way can be used.

The central node 102 can be advantageously configured to communicate an identity (ID) of the device 104 to be located to the positioning devices 106, 108, 110 in the system 100. The devices 106, 108, 110 can then be configured to use the ID for identifying signals from the device 104. Many forms of the ID are expected to be suitable. For example, the device 104 can be identified by its medium access control (MAC) address or by another form of ID included by the central node 102 in one or more messages sent to the positioning devices 106, 108, 110. In an alternative arrangement, the central node 102 can be configured to assign an ID, such as an internet protocol (IP) address, to the device 104 and to communicate the assigned ID to the device 104 and the positioning devices 106, 108, 110. For example, an ID can be included in a part of the message according to the extensible mark-up language (XML) protocol.

Each of the positioning devices 106, 108, 110 is configured to communicate with the device 104 to be located and to forward information about that communication to the central node 102. Based on the forwarded information, the central node 102 can be configured to determine the location of the device 104. An alternative, of course, is that the central node 102 can be configured to forward the information it receives from the positioning nodes 106, 108, 110 to another device that can determine the location of the device 104. Another alternative is that the central node 102 can itself communicate directly with the device 104, thereby taking the place of one of the positioning nodes 106, 108, 110.

Each positioning device advantageously can be configured to request information from the device 104, or simply to receive information from the device 104, or both. In any case, a positioning device 106, 108, 110 communicates that information to the central node 102. Thus in the example depicted in FIG. 1, the positioning device 106 obtains information X, positioning device 108 obtains information Y, and positioning device 110 obtains information Z. As described above, the central node 102 can be configured to determine the location of the device 104 based on the informations X, Y, and Z.

It will be understood that it can be advantageous for the system nodes 102, 104, 106, 108, 110 to have respective IDs that are known by other nodes. For example, a node can transmit its ID as a radio signal in an RFID exchange, or as a modulated optical (infrared, visible, etc.) signal, etc. The positioning devices 106, 108, 110, which can themselves be sensors, actuators, etc., include their respective IDs in the sensor readings and location information they communicate to the central node 102. It will be appreciated that the communication medium used by each positioning/sensor device 106, 108, 110 for communicating its sensor readings need not be the same as the communication medium it uses for communicating location information relating to the device 104. For example, RFID-based location communication can be used with wired sensors, optical-based location communication can be used with wireless sensors, etc.

In the system depicted in FIG. 1, the central node 102 for example can be configured to determine the location of the device 104 based on the informations X, Y, and Z from the positioning devices 106, 108, 110. The central node 102 can be configured to determine the location in any convenient way, such as based on times of arrival or strengths at the positioning devices, and even at the central node, of a signal transmitted by the device 104. Of course, the device 104 might include a GPS or other location device, and so the device 104 can be configured simply to transmit its location to the positioning devices and/or central node.

After determining the location, the central node 102 annotates signals received from the device 104 with that location before communicating the annotated signals to another device or network 112. For example, when the central or gateway node 102 has location information for a temperature sensor 104 having an identity S, the gateway 102 annotates temperature messages sent by the sensor 104 with the sensor's location. In this example, if the sensor 104 sends a message that “The temperature reading of Sensor S is T”, the gateway 102 can add S's position to the message and forward the annotated message to the device(s)/network(s) 112, or the gateway 102 can add the sensor's position to a database of sensor positions that it can separately query when necessary, e.g., when a message is received from the sensor that is to be forwarded.

It will be understood that after the location of a device 104 has been determined, the central node 102 can communicate the location to one or more of the positioning devices 106, 108, 110, and even to the device 104. Thus, a positioning device 106, 108, or 110 that knows the position and ID of the device 104 can communicate that information to the central node 102 with the information used by the central node for determining the location of the device 104. The central node 102 can then be able to determine movement of the device 104 more readily and more surely.

It can be seen that the positioning devices 106, 108, 110 advantageously add location information to messages they send in a way that is substantially transparent to the device 104. The central node or gateway 102 is a network-side positioning mechanism that determines the location of a sensor or other Machine to Machine (M2M) device 104. Determined location(s) can then simply be added by the gateway 102 to the data flow(s) coming from the device(s) 104, which can be temperature, humidity, illumination, or other signals appropriate for sensors or actuators or other entities of a network. Thus, it can be seen that the central node 102 is more than merely a conventional network router and can be instructed, for example, to actuate devices 104 to cause one or more lamps in a given area to be switched on or off.

Messages exchanged by entities in the system 100 and other devices or networks 112 are typically formulated in accordance with an agreed-on communication protocol, such as the IP, the hypertext transfer protocol (HTTP), etc. Identities of the devices 104, 106, 108, 110, can thus include MAC addresses as noted above as well as IP source addresses, uniform resource informations (URIs), etc. The central node 102 and possibly other nodes in the system 100 are configured to annotate messages in any convenient way according to the communication protocol, for example by including or modifying one or more information elements to carry the necessary information.

In this application, the words “gateway” and “central node” refer to an end-point device that can be tasked to perform requests on behalf of a device 104, such as a sensor or actuator. In the literature, such a device can have different names. For instance, the Constrained Application Protocol (CoAP) being developed by the Internet Engineering Task Force (IETF) calls such a device a “proxy”. A draft called “Constrained Application Protocol (CoAP)” is available in the IETF archive, currently on the internet at tools.ietf.org/html/draft-ietf-core-coap-08, and is incorporated here by reference.

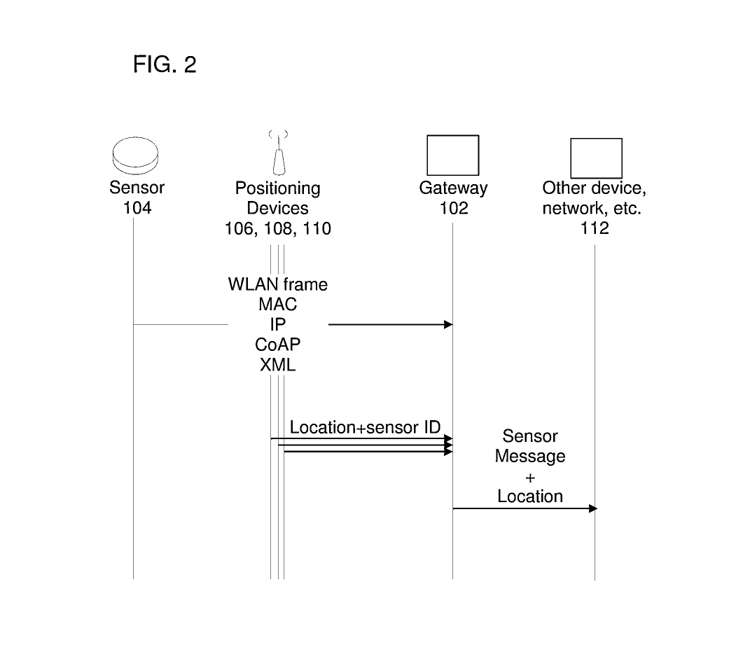

FIG. 2 is a diagram of an example of signal flow among entities in the location system depicted in FIG. 1. In FIG. 2, the device 104 is assumed to communicate wirelessly with the central node 102. Positioning devices 106, 108, 110 monitor signals exchanged by the node 102 and device 104, and those signals can include, for example, signals in a wireless local area network (WLAN) according to MAC, IP, and CoAP protocols, which can include XML information elements. Based on those signals, the positioning devices 106, 108, 110 can determine the ID of the device 104 and can provide information, such as ToA, signal strength, etc., to the node 102 for locating the device 104. As described above, the node 102 can be configured to aggregate location information from several positioning devices and possibly itself to determine the location of the device 104. In determining an absolute location of the device 104 rather than a relative location with respect to the positioning device(s), the gateway can use known locations of the positioning devices. Once the gateway 102 has determined the location of the device 104, the gateway includes that location in messages from the device 104 that the gateway passes to other devices or networks 112, such as home or office environmental control systems and other control and information systems. For example, the gateway 102 can be configured to include a semantic representation of the location of the device 104 to facilitate human interaction with the device 104 and system 100.

It should be understood that the ID of a device 104 need not always be expressly communicated to the positioning devices and other entities in the system 100. Instead or in addition, the ID can be implicitly communicated, e.g., using the MAC address of the device 104 for correlation between positioning-device measurements and reception at the central node.

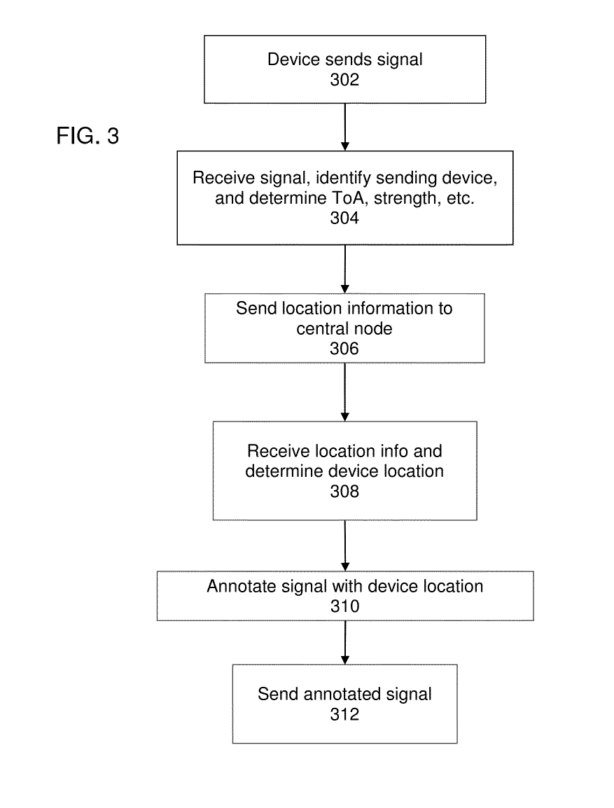

FIG. 3 is a flowchart of an example of a method of determining the location of a device and tagging signals from the device with the location in accordance with this invention. The example in FIG. 3 relates to a system 100 such as that depicted in FIG. 1 with a signal flow such as that depicted in FIG. 2.

In step 302, a device 104 to be located sends a signal, such as a message over a WLAN, which can be a signal in the normal course of the device's operation or a signal suitably configured for location of the device 104. In a WLAN, the message typically includes the MAC address of the device 104 and can be in accordance with protocols such as the IP and CoAP.

In step 304, a positioning device 106, 108, 110 “overhears”, or more generally receives, the signal sent by the device 104, identifies the sending device by its MAC address, for example, and determines location information based on the signal received. As described above, the location information can include one or more of the ToA of the signal, the signal strength of the signal, etc. In step 306, the positioning device sends the location information with an indication of the identity of the sending device 104 to the central node 102.

In step 308, the central node 102 receives location informations from positioning devices and determines the location of the device 104 based on the location information from the positioning devices 106, 108, 110. In step 310, the central node 102 annotates the signal or message received from the device 104 with the determined location, e.g., according to CoAP, HTTP, etc., thereby forming a second signal.

In step 312, the central node 102 sends the second signal, i.e., the device signal or message annotated with the device location, to another device or network 112 that can use the signal and location.

As described above, devices 104, such as sensors, actuators, etc., do not need modification or special equipment to benefit from location-aware technology. A location system also enjoys minimal interaction with the devices 104, simplifying system operation and management; and the gateway or central node 102 has information about the locations of the devices 104.

In many implementations of this invention, location and identity tagging can be carried out by having the positioning devices 106, 108, 110 simply passively monitor signals sent by the sensor or other device 104 as described above. Nevertheless, it should be understood that this invention can be implemented by active signaling, e.g., positioning devices 106, 108, 110 can broadcast otherwise conventional RFID signals and within-range sensors 104 can respond by sending signals that include their identities. With a device 104 stimulated to send a signal, the positioning devices can use that signal for location and tagging as described above. It will be noted that attaching an RFID responder to a sensor is simpler and cheaper than including, for example, a GPS device and transmitter in the sensor.

It will also be appreciated that the determination of the location of a device 104 need not be carried out in the central node 102. Location determination can be carried out in other system nodes, such as one or more of the positioning devices 106, 108, 110. Moreover, in addition to a machine-understandable location, a human-understandable, or semantic, location (e.g., “Temperature reading of Sensor in Kitchen is T”) can also be added to the signal from the device 104. It will be further appreciated that the central node 102 advantageously passes signals from devices 104 to device(s)/network(s) 112 even if it has not determined locations and identities of the devices. Of course, when locations and identities of the devices have been determined, the central node annotates signals from the devices with information as described above.

In another embodiment, information flow can flow from the central node 102 to the device(s) 104. For example, the central node 102 can pass control and other signals from device(s)/network(s) 112 outside the system 100 to devices 104 inside the system.

FIG. 4 is a block diagram of an example of a suitable central node 102, and to a large extent, examples of suitable devices 104 and positioning devices 106, 108, 110 for a location system 100. The example node 102 includes an electronic processor circuit 402, an electronic memory 404, a signal transmitter/receiver (transceiver) 406, and an interface 408. As depicted, the transceiver 406 sends signals to and receives signals from the device 104 and positioning devices 106, 108, 110, and the interface 408 sends signals to and receives signals from other devices and networks outside the location system 100. It will be understood that the particular functions carried out by the transceiver 406 and interface 408 depend on the nature (e.g., wired or wireless) of the links carrying the respective signals.

Some or all of the functionalities described above as being provided by the central node 102, or any of the other entities in the system 100, can be implemented by the processor 402's execution of program instructions stored on a computer-readable medium, such as the memory 404 shown in FIG. 4. Thus, it can be understood that the system node for a system for determining a location of a device 104 and tagging signals from the device 104 with the device's location can include an electronic processor circuit 402 configured for determining, based on respective location information included in a plurality of different positioning signals received by the system node, the location of the device; and for forming, from a signal sent by the device and received by the system node, a second signal annotated with the location of the device. The respective location information is based on the signal sent by the device 104.

Alternative embodiments of the central node 102 and of other system entities 104, 106, 108, 110 can include additional components beyond those shown in FIG. 4 that can be responsible for providing aspects of additional functionality, including any of the functionality described in this application and/or any functionality necessary to support the methods described in this application. In a similar way, alternative embodiments of the central node 102 and of other system entities 104, 106, 108, 110 can include fewer components than those shown in FIG. 4 that provide aspects of reduced functionality, including any of the functionality described in this application and/or any functionality necessary to support the methods described in this application.

It will be appreciated that the methods and devices described above can be combined and re-arranged in a variety of equivalent ways, and that the methods can be performed by one or more suitably programmed or configured digital signal processors and other known electronic circuits (e.g., discrete logic gates interconnected to perform a specialized function, or application-specific integrated circuits). It will be recognized that various actions can be performed by specialized circuits (e.g., discrete logic gates interconnected to perform a specialized function or application-specific integrated circuits), by program instructions executed by one or more processors, or by a combination of both.

Many aspects of this invention are described in terms of sequences of actions that can be performed by, for example, elements of a programmable computer system. Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, or transport the program for use by or in connection with the instruction-execution system, apparatus, or device. The computer-readable medium can be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer disk or memory card, a random-access memory (RAM), a read-only memory (ROM), an erasable programmable read-only memory (EPROM or Flash memory), and an optical fiber.

It will be appreciated that procedures described above are carried out repetitively as necessary, for example, to respond to the time-varying nature of communication channels between transmitters and receivers. In addition, it will be understood that the methods and apparatus described here can be implemented in various system nodes.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

What is claimed is:

1. A method of determining a location of a device and tagging signals from the device with the location, comprising:
receiving, by a plurality of positioning devices, a signal sent by the device;
determining, by each of the plurality of positioning devices, respective location information based on the signal;
determining, based on the respective location information of each of the plurality of positioning devices, the location of the device; and
forming, from the signal, a second signal annotated with the location of the device.

2. The method of claim 1, wherein determining a location information includes determining either a time of arrival or a strength of the signal.

3. The method of claim 1, wherein the signal is a radio-frequency identification (RFID) signal.

4. The method of claim 1, further comprising sending the second signal to another device or network.

5. The method of claim 1, wherein the signal includes an identity of the device.

6. The method of claim 1, wherein determining the location of the device includes receiving respective location information and an identity of the device from each of the plurality of positioning devices.

7. A system for determining a location of a device and tagging signals from the device with the location, comprising:
a plurality of positioning devices configured for receiving a signal sent by the device and for determining respective location information based on the signal; and
a system node configured for determining, based on the respective location information of each of the plurality of positioning devices, the location of the device and for forming, from the signal, a second signal annotated with the location of the device.

8. The system of claim 7, wherein a positioning device is configured for determining location information by determining either a time of arrival or a strength of the signal.

9. The system of claim 7, wherein the signal is a radio-frequency identification (RFID) signal.

10. The system of claim 7, wherein the system node is further configured for sending the second signal to another device or network.

11. The system of claim 7, wherein the signal includes an identity of the device.

12. The system of claim 7, wherein the system node is configured for determining the location of the device by at least receiving respective location information and an identity of the device from each of the plurality of positioning devices.

13. A system node for a system for determining a location of a device and tagging signals from the device with the location, comprising an electronic processor circuit configured for determining, based on respective location information included in a plurality of different positioning signals received by the system node, the location of the device; and for forming, from a signal sent by the device and received by the system node, a second signal annotated with the location of the device; wherein the respective location information is based on the signal sent by the device.

14. The system node of claim 13, wherein the respective location information includes either a time of arrival or a strength of the signal sent by the device.

15. The system node of claim 13, wherein the system node is further configured for sending the second signal to another device or network.

16. The system node of claim 13, wherein the signal sent by the device includes an identity of the device.
